(19) United States
(12) Patent Application Publication
(10) Pub. No.: US 2004/0213511 A1
(43) Pub. Date: Oct. 28, 2004

(54) Erbium doped waveguide amplifier (EDWA) with pump reflector

(76) Inventor: Christopher J. Scholz, Santa Clara, CA (US)

Correspondence Address: Jan Carol Little, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/102,363

(22) Filed: Mar. 19, 2002

(51) Int. Cl. G02B 6/26; H04B 10/12; H04J 14/02

(52) U.S. Cl. 385/27; 359/341.1

(57) ABSTRACT

A waveguide amplifier having an input coupler, a gain stage, and a pump reflector monolithically integrated on a common substrate. The input coupler multiplexes pump light with signal light, the active region of the gain stage absorbs some of the pump light, amplifies the signal light, and passes the unabsorbed pump light and/or any unabsorbed amplified spontaneous emissions (ASE) to the reflector. The reflector reflects the unabsorbed pump light and/or any unabsorbed amplified spontaneous emissions (ASE) back into the active region of the gain stage to improve the efficiency of the waveguide amplifier.

### BACKGROUND OF THE INVENTION

1. Field of the Invention

The present invention is related to optical systems and components and, in particular, to waveguide amplifiers.

2. Background Information

An optical transmission system transmits information from one place to another by way of a carrier whose frequency is in the visible or near-infrared region of the electromagnetic spectrum. A carrier with such a high frequency is sometimes referred to as an optical signal, an optical carrier, or a lightwave signal.

An optical transmission system commonly includes several optical fibers. Each optical fiber includes one or more channels. A channel is a specified frequency band of an electromagnetic signal, and is sometimes referred to as a wavelength. One link of an optical transmission system typically has a transmitter, the optical fiber, and a receiver. The transmitter converts an electrical signal into the optical signal and launches it into the optical fiber. The optical fiber transports the optical signal to the receiver. The receiver converts the optical signal back into an electrical signal.

An optical transmission system that transmits more than one channel over the same optical fiber is sometimes referred to as a multiple channel system. The purpose for using multiple channels in the same optical fiber is to take advantage of the unprecedented capacity offered by optical fibers. Essentially, each channel has its own wavelength, and all wavelengths are separated enough to prevent overlap.

One way to transmit multiple channels is through wavelength division multiplexing, whereupon several wavelengths are transmitted in the same optical fiber. Typically, multiple channels are interleaved by a multiplexer, launched into the optical fiber, and separated by a demultiplexer at a receiver. Wavelength division demultiplexing elements separate the individual wavelengths using frequency-selective components such as optical gratings or other bandpass filters.

Optical signals traveling over long distances need to be regenerated periodically to compensate for fiber loss, sometimes referred to as signal attenuation. Fiber loss reduces the average signal power reaching the receiver. Because optical receivers need a certain amount of power in order to recover the optical signal accurately, the transmission distance of the optical signal is limited by fiber loss.

Optical signal regeneration sometimes utilizes optoelectronic regenerators. A typical optoelectronic regenerator employs a receiver-transmitter pair that detects the incoming optical signal, converts it into an electrical signal, amplifies, reshapes, retimes, and performs higher layer processing of the electrical signal, and then converts the amplified electrical signal back into a corresponding optical signal. However, optoelectronic regenerators are quite complex and expensive for multiple channel systems. Additionally, the electronic components in optoelectronic regenerators cause transmission system bandwidth to be limited.

Multiple channel lightwave systems benefit considerably when optoelectronic regenerators are replaced by much simpler erbium doped fiber amplifiers (EDFA). Loss compensation is accomplished in erbium doped fiber amplifiers (EDFAs) by amplifying the optical signal directly, without converting it to an electrical signal. In either case, regeneration boosts the signal level and corrects for transmission impairments. Erbium doped fiber amplifiers (EDFA) are large and bulky subsystems, however, because they are composed of discrete components (the spool of erbium-doped optical fiber, a laser to produce pump light, isolators to prevent light back-reflection, fiber combiners to combine pump energy and signal energy, and other components).

In recent years, erbium doped waveguide amplifiers (EDWA), which are relatively small, discrete amplifiers disposed on a substrate, have been used to amplify weak optical signals. A typical waveguide amplifier has a tiny waveguide doped with erbium ions. The optical fiber is coupled to a small pump laser diode, which emits photons of an energy level to cause electrons from the erbium ions to be elevated into an excited state. Pump sources such as laser diodes are known to be efficient when pumping at 980 nm and 1480 nm wavelengths. However, some of the pump energy still manages to remain unabsorbed by the waveguide amplifier. Unabsorbed pump energy is commonly removed using discrete filters and/or evanescent couplers. However, removing unabsorbed pump energy this way still leaves margins for higher efficiencies.

### BRIEF DESCRIPTION OF THE DRAWINGS

In the drawings, like reference numbers generally indicate identical, functionally similar, and/or structurally equivalent elements. The drawing in which an element first appears is indicated by the leftmost digit(s) in the reference number, in which:

FIG. 1 is a high-level block diagram of a waveguide amplifier according to embodiments of the present invention;

FIG. 2 is a flowchart of an approach to amplifying an optical signal according to embodiments of the present invention;

FIG. 3 is a high-level block diagram of an alternative waveguide amplifier according to embodiments of the present invention;

FIG. 4 is a high-level block diagram of an optical system according to embodiments of the present invention; and

FIG. 5 is a flowchart of a process for fabricating waveguide amplifiers in accordance with embodiments of the present invention.

### DETAILED DESCRIPTION OF THE ILLUSTRATED EMBODIMENTS OF THE PRESENT INVENTION

An erbium-doped waveguide amplifier is described herein. In the following description, numerous specific details, such as particular processes, materials, devices, and so forth, are presented to provide a thorough understanding of embodiments of the invention. One skilled in the relevant art will recognize, however, that the invention can be practiced without one or more of the specific details, or with other methods, components, etc. In other instances, well-known structures or operations are not shown or described in detail to avoid obscuring various embodiments of the invention.

Some parts of the description will be presented using terms such as waveguide, waveguide amplifier, gain, wavelength, and so forth. These terms are commonly employed by those skilled in the art to convey the substance of their work to others skilled in the art.

Other parts of the description will be presented in terms of operations performed by a computer system, using terms such as accessing, determining, counting, transmitting, and so forth. As is well understood by those skilled in the art, these quantities and operations take the form of electrical, magnetic, or optical signals capable of being stored, transferred, combined, and otherwise manipulated through mechanical and electrical components of a computer system; and the term “computer system” includes general purpose as well as special purpose data processing machines, systems, and the like, that are standalone, adjunct or embedded.

Various operations will be described as multiple discrete blocks performed in turn in a manner that is most helpful in understanding the invention. However, the order in which they are described should not be construed to imply that these operations are necessarily order dependent or that the operations be performed in the order in which the blocks are presented.

Reference throughout this specification to “one embodiment” or “an embodiment” means that a particular feature, structure, process, block, or characteristic described in connection with the embodiment of the present invention is included in at least one embodiment of the present invention. Thus, the appearances of the phrases “in one embodiment” or “in an embodiment” in various places throughout this specification are not necessarily all referring to the same embodiment of the present invention. Furthermore, the particular features, structures, or characteristics may be combined in any suitable manner in one or more embodiments of the present invention.

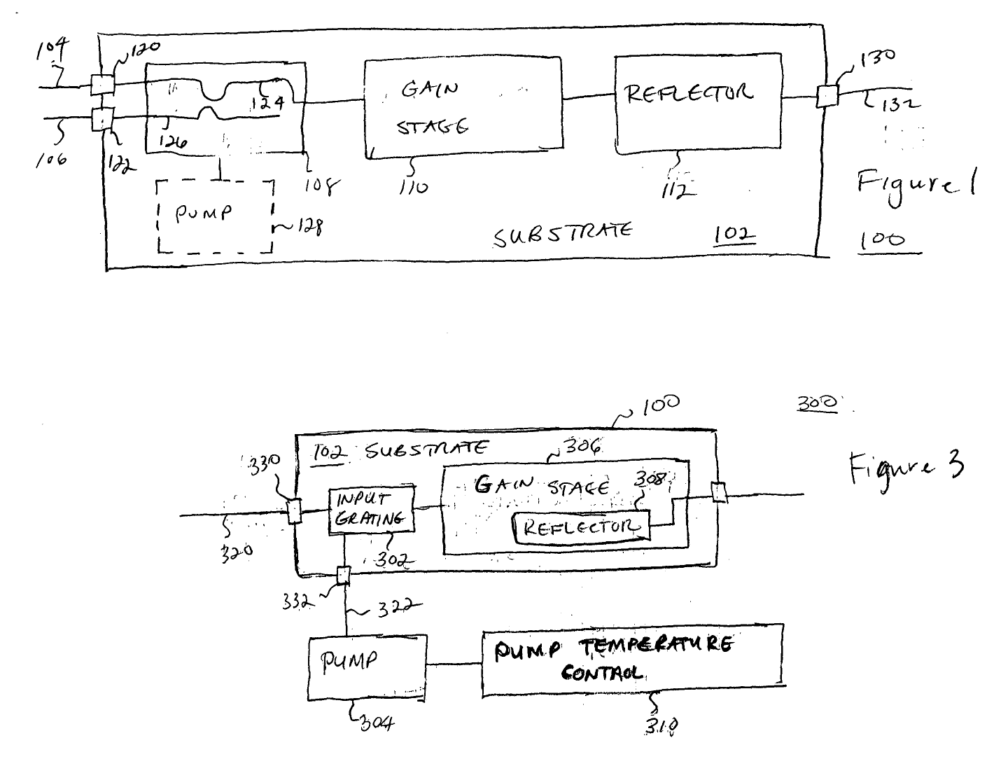

FIG. 1 is a high-level block diagram of a waveguide amplifier 100 according to embodiments of the present invention. The example waveguide amplifier 100 includes a substrate 102, an signal light input 104 coupled onto the substrate 102, a pump light input 106 coupled to the substrate 102, an input coupler 108 disposed on or in the substrate 102 and coupled to the signal light input 104 and the pump light input 106, a gain stage 110 disposed on or in the substrate 102 and having an input coupled to the input coupler 108, and a reflector 112 disposed on or in the substrate 102 and coupled to an output of the gain stage 110.

The signal light input 104 and pump light input 106 may be coupled to the substrate 102 via a signal light interface 120 and a pump light interface 122, respectively. The input coupler 108 may include a signal light waveguide element 124 and a pump waveguide element 126 coupled to the optical signal interface 120 and a pump light interface 122, respectively. The signal light waveguide element 124 may be coupled to the input of the gain stage 110. The output of the reflector 112 is coupled off the substrate 102 via an output interface 130.

The substrate 102 may be a silicon substrate, a silicon-on-insulator (SOI) substrate, a silicon-on-sapphire (SOS) substrate, a glass substrate, or an aluminum oxide substrate. Other substrates suitable for implementing the substrate 102 are well known.

The signal light input 104 and pump energy input 106 may be any optical waveguide that couples light from one place to another, such as planar waveguides, optical fibers, or any combination thereof. Optical fibers and planar waveguides suitable for implementing the signal light input 104 and pump light input 106 are well known. Pump light may be 980 nm.

The input coupler 108 may be a wavelength division multiplexing (WDM) directional (or Y) coupler, which multiplexes pump energy with the optical energy. Both the signal light waveguide element 124 and the pump waveguide element 126 have a higher index of refraction than the substrate 102. The input coupler 108 may be defined on or in the substrate 102 using suitable well-known techniques.

The signal light interface 120, the pump energy interface 122, and the output interface may be any suitable interface that couples light onto and/or off of the substrate 102. Suitable interfaces are well known.

The gain stage 110 may be a waveguide defined on or in the substrate 102 and doped or co-doped with one or more active materials such as a lanthanide species including erbium (Er) ions, ytterbium (Yb) ions, praseodymium (Pr) ions, neodymium (Nd), or other suitable impurity. For example, the gain stage 110 may be co-doped with Er and Yb ions.

The gain stage 110 has absorption and fluorescence properties, which determine which wavelengths are amplified efficiently. The absorption and fluorescence properties for various active materials are well known. For example, it is well known that Er has a fluorescence peak near 1530 nm, that Yb has fluorescence peaks near 980 nm and 1030 nm, that Pr has fluorescence peaks near 880 nm, 1060 nm, and 1320 nm, and that Nd has a fluorescence peak near 1060 nm. Absorption and fluorescence properties for other active materials are well known and, after reading the description herein, persons of ordinary skill in the relevant art(s) will know how to implement embodiments of the present invention for other active materials.

The reflector 112 may be a series of refractive index perturbations disposed on or in the substrate 102 (e.g., by masking the substrate 102 and lasing the mask to define the perturbations). The refractive index perturbations reflect light within a selected wavelength band and pass wavelengths outside of the selected wavelength band. The reflected wavelength λ_{B} is represented by

λ_{B}=2n/Λ (Equation 1)

where A is the period of the grating and n is the index of refraction. The index of refractions varies over the length of the grating. The periodicity of the refractive index perturbations (or distance between two adjacent grating peaks) defines, in part, the wavelength of light to be reflected by reflector 112.

According to embodiments of the present invention, the reflector 112 may be a grating monolithically integrated in or on the substrate 102 that reflects light back into the gain stage 110 at an angle different than the angle of incident light (e.g., diffraction grating). Alternatively, the reflector 112 may be a grating monolithically integrated in or on the substrate 102 that reflects light back into the gain stage 110 at an angle that is the same as the angle of incident light (e.g., Bragg grating). Alternatively, the reflector 112 may be a long period grating or other suitable grating. After reading the description herein, it will be apparent to persons of ordinary skill in the relevant art(s) how to implement the reflector 112 using various gratings.

During operation, a signal light to be amplified by the waveguide amplifier 100 is coupled onto the substrate 102 and to the signal light waveguide element 124 via the signal light input 104 and the signal light interface 120. Pump light is coupled onto the substrate 102 and to the pump light waveguide element 126 via the pump light input 106 and the pump light interface 122. The input coupler 108 multiplexes the signal light and the pump light and couples the multiplexed signal to the gain stage 110. The pump light may be 980 nm photons, 1480 nm photons, or other suitable wavelength. The active material in the gain stage 110 absorbs a portion of the pump energy and (the outer electrons in) the active material becomes excited.

When excited ions decay, they emit photons as well, which may be “stimulated emissions” or “spontaneous emissions.” Stimulated emission is initiated by an existing photon (e.g., from the light to be amplified). As active material atoms (or ions) drop back to a stable state, they give off a photon of a particular wavelength, which can stimulate other active material atoms. When the stimulated active material atoms drop back to a stable state, they, too, emit of a photon, which matches the original photon in energy level, direction of propagation, and wavelength, for example. Stimulated emission causes the optical signal in the multiplexed signal to be amplified.

In the case of spontaneous emission, photons are emitted in random directions with no phase relationship among them. Spontaneous emissions can cause noise in waveguide amplifiers and when several waveguide amplifiers are cascaded together, spontaneous emissions from each waveguide amplifier propagate to other waveguide amplifiers and are amplified by each successive waveguide amplifier. These “amplified spontaneous emissions (ASE)” accumulate and affect the quality of the optical signal (and data carried on the optical signal) being propagated from source to destination. Additionally, as ASE grows, the waveguide amplifiers along the path of the propagating optical signal begin to become saturated, which degrades the signal-to-noise ratio (SNR).

According to embodiments of the present invention, the reflector 112 may exhibit high reflectivity near 980 nm such that the reflector 112 reflects unabsorbed pump energy as well as unabsorbed Yb ASE having a fluorescence peak at 980 nm. The reflector 112 also may exhibit low reflectivity in the third fiber communication window encompassing the S-band (e.g., 196.00 terahertz (THz) to 200.90 THz), C-band (e.g., 191.00 THz to 195.90 THz), and the L-band (e.g., 186.00 THz to 190.90 THz). As a result, the reflector 112 passes amplified optical signals near this range with little attenuation. The reflected light (e.g., unabsorbed pump light and/or ASE) is used in the gain stage 110 to provide greater amplification of the signal light. These and other embodiments of the present invention provide a more efficient utilization of pump energy, which in turn leads to greater pumping efficiency.

Of course, the reflector 112 may have other periodicities to efficiently reflect unabsorbed pump energy and unabsorbed ASE having other fluorescence peaks. The active material in the gain stage 110 determines the ranges of wavelengths reflected and/or passed by the reflector 112. After reading the description herein, persons of ordinary skill in the relevant art(s) will readily recognize how to implement the waveguide amplifier 100 for unabsorbed pump energy and unabsorbed ASE having other fluorescence peaks.

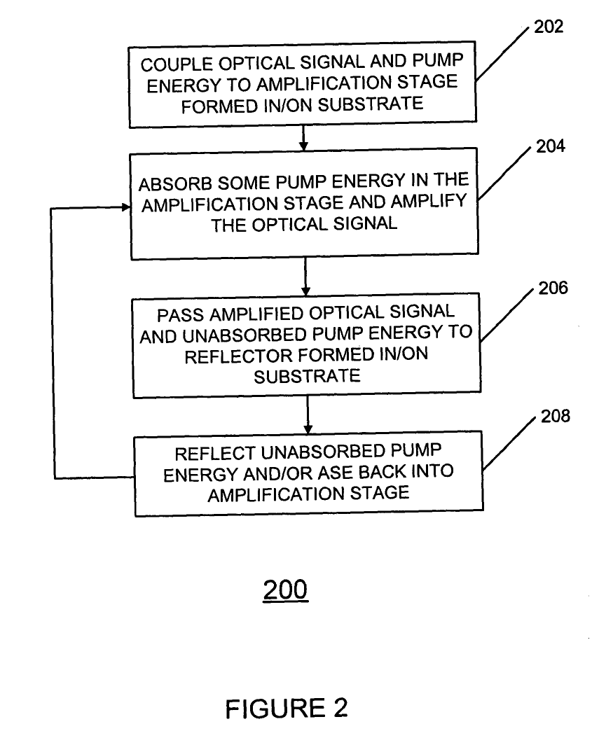

FIG. 2 is a flowchart illustrating a process 200 for amplifying signal light according to embodiments of the present invention. Of course, other processes for amplifying signal light according to embodiments of the present invention are possible.

In a block 202, signal light and pump light are coupled to a gain stage disposed on or in a substrate. In one embodiment of the present invention, the gain stage is co-doped with Er and Yb ions, the pump light is 980 nm, and the substrate is an SOI optical bench.

In a block 204, the gain stage absorbs some of the pump light and amplifies the signal light. The type of the active material in the gain stage determines the wavelengths of the pump light that is absorbed and signal light that is amplified.

In a block 206, the gain stage passes the amplified signal light, ASE, and/or unabsorbed pump light to a reflector disposed in or on the same substrate in or on which the gain stage is disposed.

In a block 208, the reflector reflects the ASE and/or unabsorbed pump light back into the gain stage. The periodicity of the refractive index perturbations in the reflector determines the wavelength(s) of the ASE and/or unabsorbed pump light that is reflected back into the gain stage.

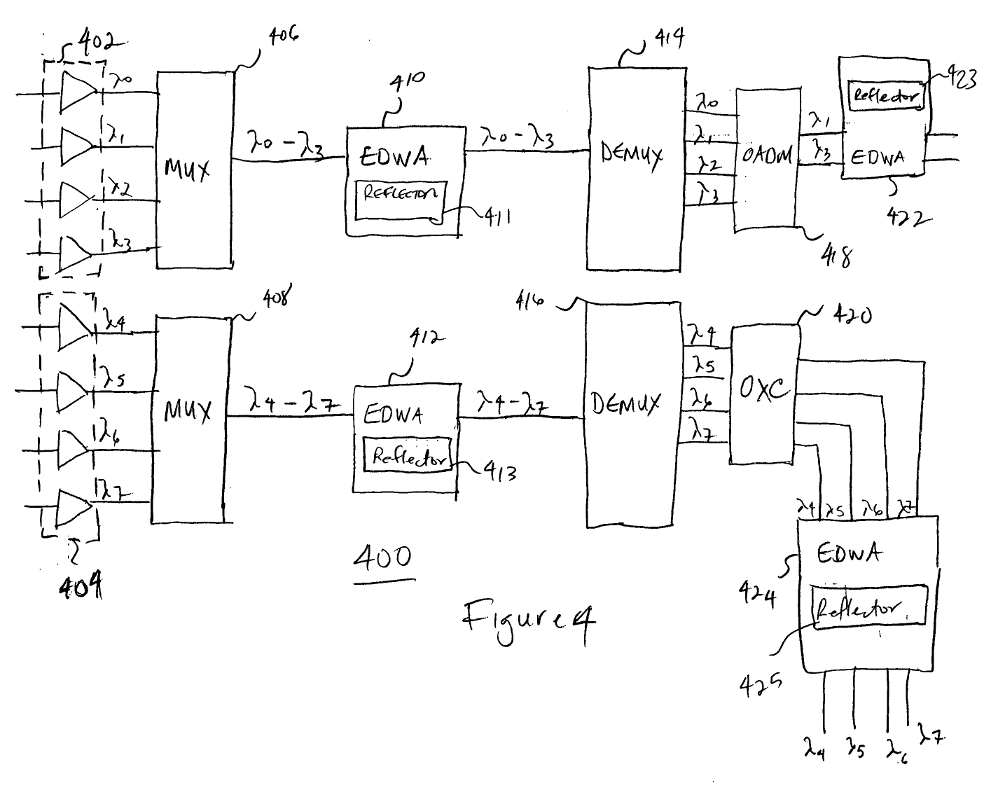

FIG. 3 is a high-level block diagram of an alternative waveguide amplifier 300 according to embodiments of the present invention. The example waveguide amplifier 300 includes an input grating 302 and a gain stage 306 disposed on or in the substrate 102.

The input grating 302 multiplexes the signal light 320 and the pump light 322, and couples the multiplexed light to the gain stage 306. The gain stage 306 includes an active material, which amplifies the signal light in the multiplexed light and produces out-of-band ASE, (e.g., fluorescence that is significantly far away from the transmission band of interest (e.g., S-band, C-band, L-band)). The active material in the gain stage 306 absorbs some of the pump light 322 and some of the ASE and passes the unabsorbed pump light 322 and ASE to a reflector 308, which may be disposed in the gain stage 306. The reflector 308 may reflect ASE and/or unabsorbed pump light back into the active region of gain stage 306. Integrating the reflector 308 into the gain stage 306 may reduce optical coupling losses that may occur when a reflector is coupled to a gain stage via an optical fiber.

Signal light 320 may be coupled to the substrate 102 via a coupler 330. Pump light may be coupled to the substrate 102 via a coupler 332. An external pump 304 may provide the pump light 322 to the input grating 302. A pump temperature control 310 may be coupled to the pump 304 to control the temperature of the pump 304 when the pump 304 is generating pump light 322.

FIG. 4 is a high-level block diagram of an optical system 400 according to embodiments of the present invention. The optical system 400 includes two sets of optical amplifiers (402, 404) whose outputs (λ₀, λ₁, λ₂, λ₃ . . . λ₇) are coupled to a pair of multiplexers (406, 408, respectively). The outputs of the multiplexers 406, 408 are coupled to a pair of erbium doped waveguide amplifiers (EDWA) (410, 412, respectively), which include reflectors (411, 413, respectively) on the same substrate as the gain stage to reflect unabsorbed pump light and/or ASE according to embodiments of the present invention.

The outputs of the EDWA 410, 412 are coupled to a pair of demultiplexers (414, 416, respectively). The outputs (λ₀ . . . λ₇) of the demultiplexers 414, 416 are coupled to an optical add/drop multiplexer (OADM) 418 and an optical cross connect (OXC) switch 420, respectively. The outputs OADM 418 (λ₁, λ₃) and the OXC switch 420 (λ₄-λ₇) are coupled to a pair of erbium doped waveguide amplifiers (EDWA) (422, 424, respectively), which include reflectors (423, 425, respectively) on the same substrate as the gain stage to reflect unabsorbed pump light and/or ASE according to embodiments of the present invention.

The optical amplifiers in the two sets of optical amplifiers (402, 404) may be any well-known or future optical fiber amplifiers, which amplify and/or regenerate optical signals (e.g., optoelectronic regenerators).

The multiplexers 406, 408 may be any well-known or future photonic devices that combine several single channels (or wavelengths) into a multiple channel (or multiple wavelength) signal (e.g., a discrete arrayed waveguide grating (AWG) multiplexer).

The pair of demultiplexers 414, 416, may be any well-known or future photonic devices that separates a multiple channel (or wavelength) signal into several single channels (or wavelengths) out of a multiple channel (or multiple wavelength) signal or (e.g., a discrete AWG demultiplexer).

The OADM 418 may be any well-known or future photonic device adds one or more single channels (or wavelengths) to a multiple channel (or multiple wavelength) signal or that separates one or more single channels (or wavelengths) out of a multiple channel (or multiple wavelength) signal or (e.g., switches coupled between a discrete AWG multiplexer and a discrete AWG demultiplexer).

The OXC switch 420 may be any well-known or future photonic device that connects and/or disconnects one or more channels (or wavelengths) to/from other photonic devices.

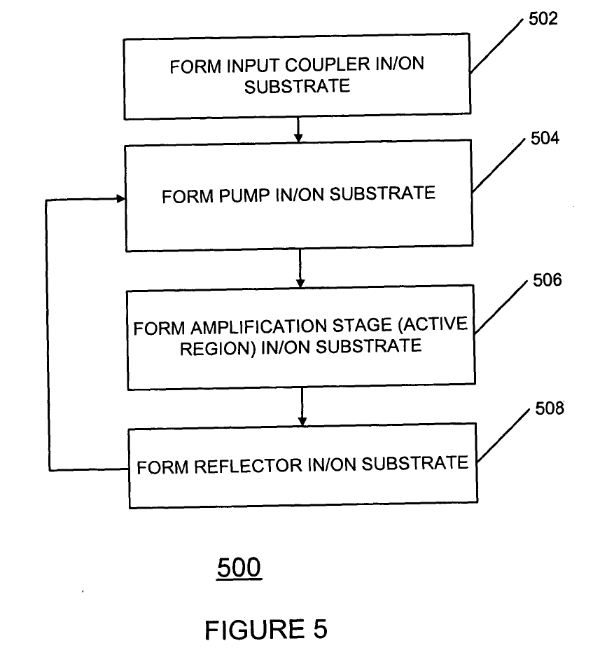

FIG. 5 is a flowchart of a process 500 for fabricating waveguide amplifiers in accordance with embodiments of the present invention. A machine-readable medium having machine-readable instructions thereon may be used to cause a processor to perform the process 500. In general, the process 500 is implemented using standard semiconductor and grating fabrication techniques, such as implantation, doping, evaporation, chemical-vapor deposition, physical vapor deposition, ion assisted deposition, photolithography, magnetron sputtering, electron beam sputtering, evaporation, masking, reactive ion etching, and/or other semiconductor and grating fabrication techniques well known to those skilled in the art.

In a block 502, an input coupler is disposed in or on a substrate. In a block 504, a pump is disposed in or on the substrate. In a block 506, a gain stage with an active material is formed in or on the substrate. In a block 508, a reflector is formed in or on the substrate. Alternatively, the reflector may be formed in or on the non-active region of the gain stage.

Any or all of the waveguide amplifier 100 components may be monolithically integrated on or in the substrate 102 using well known techniques. For example, thermal oxidation, flame hydrolysis deposition, chemical vapor deposition, optical lithography, etching (e.g., reactive ion etching), and/or chemical vapor deposition, may be used to fabricate the waveguide amplifier 100.

There are several advantages of integrating waveguide amplifier components onto a single chip according to embodiments of the present invention. First is reduced cost because the individual integrated optical circuits (e.g., gain stage with reflectors) may be fabricated in the same processes that electronic components are generally fabricated (e.g., by semiconductor processes in the fabrication facilities). This means that adding more components on the chip provides the functionality of several discrete components for a small increment in price compared with one integrated component.

Second is power savings realized by integrating components onto a common substrate. For example, integration means that there are fewer optical losses because there are fewer connections via optical fiber. Conventionally, each discrete component is connected via optical fiber and each connection introduces power losses, and power losses are cumulative across connections.

Third is space savings in a system implementing the waveguide amplifier according to embodiments of the present invention, which means that chips may be smaller and conventional rack-based subsystems can be scaled down to card-based subsystems. Moreover, card-based subsystems also offer cost savings in systems integration and system testing.

Fourth is that a pump source with lower power may be used. This is because the portion of pump energy that would normally be wasted in a device with no reflector is reused in devices implemented according to embodiments of the present invention.

Waveguide amplifiers implemented according to embodiments of the present invention may be used as a stand-alone amplifier, for example, in optical networks or within urban or metropolitan areas. Metropolitan areas generally have relatively low channel counts and operate at relatively high data rates.

Waveguide amplifiers implemented according to embodiments of the present invention may be embodied in a loss compensator in long haul applications. In this embodiment of the present invention, the waveguide amplifiers may amplify a band of wavelengths rather than an entire wavelength spectrum.

Waveguide amplifiers implemented according to embodiments of the present invention may be embodied in an optical add/drop multiplexer (OADM), which inserts and extracts wavelengths from multiplexed optical signals. Alternatively, Waveguide amplifiers implemented according to embodiments of the present invention may be embodied in an optical cross-connect switch (OXC), which interconnects multiple optical fibers.

Embodiments of the invention can be implemented using hardware, software, or a combination of hardware and software. Such implementations include state machines and application specific integrated circuits (ASICs). In implementations using software, the software may be stored on a computer program product (such as an optical disk, a magnetic disk, a floppy disk, etc.) or a program storage device (such as an optical disk drive, a magnetic disk drive, a floppy disk drive, etc.).

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments of the present invention disclosed in the specification and the claims. Rather, the scope of the invention is to be determined entirely by the following claims, which are to be construed in accordance with established doctrines of claim interpretation.

1. An apparatus, comprising:
an input coupler disposed in or on a substrate to multiplex signal light and pump light;
a gain stage disposed in or on the substrate and coupled to the input coupler to receive the multiplexed signal light and pump light; and
a reflector disposed in or on the substrate and coupled to an output of the gain stage to reflect unabsorbed pump light back into the gain stage and to reflect unabsorbed amplified spontaneous emissions (ASE) back into the gain stage.

2. The apparatus of claim 1 wherein the gain stage comprises a waveguide doped with impurities.

3. The apparatus of claim 2 wherein the impurities comprise erbium (Er) ions.

4. The apparatus of claim 2 wherein the impurities comprise ytterbium (Yb) ions.

5. The apparatus of claim 2 wherein the impurities comprise praseodymium (Pr) ions.

6. The apparatus of claim 1 wherein the reflector comprises a grating having refractive index perturbations with a periodicity determined by the wavelength of the pump light.

7. The apparatus of claim 6 wherein the grating comprises a diffraction grating.

8. The apparatus of claim 6 wherein the grating comprises a transmission grating.

9. The apparatus of claim 6 wherein the grating comprises a long period grating.

10. The apparatus of claim 6 wherein the grating comprises a fiber Bragg grating.

11. The apparatus of claim 1 wherein the substrate comprises a silicon substrate.

12. The apparatus of claim 1 wherein the substrate comprises a silicon-on-insulator (SOI) substrate.

13. The apparatus of claim 1 wherein the substrate comprises a silicon-on-sapphire (SOS) substrate.

14. The apparatus of claim 1 wherein the substrate comprises a glass substrate.

15. The apparatus of claim 1 wherein the substrate comprises an aluminum oxide substrate.

16-19. (canceled)

20. A method, comprising:
multiplexing light having a first set of wavelengths with light having a second wavelength;
absorbing a first portion of the light having the second wavelength in a gain stage on an optical bench;
amplifying the light having the first set of wavelengths in the gain stage;
passing to a reflector amplified light having the first set of wavelengths, amplified spontaneous emissions (ASE) from light having the first set of wavelengths, and a second portion of light having the second wavelength; and
reflecting back into the gain stage amplified spontaneous emissions (ASE) from light having the first set of wavelengths and the second portion of light having the second wavelength.

21. The method of claim 20, wherein absorbing a first portion of the light having the second wavelength in a gain stage on an optical bench comprises absorbing light at around 980 nm.

22. The method of claim 20, wherein amplifying the light having the first set of wavelengths in the gain stage comprises amplifying light at around 1550 nm.

23. The method of claim 20, wherein reflecting back into the gain stage amplified spontaneous emissions from light having the first set of wavelengths and the second portion of light having the second wavelength comprises reflecting back into the gain stage amplified spontaneous emissions having a wavelength of around 980 nm and the second portion of light having a wavelength of around 980 nm.
